(19) United States
(12) Patent Application Publication
(10) Pub. No.: US 2016/0180462 A1
(43) Pub. Date: Jun. 23, 2016

(54) Methodology and System For Creating And Trading A Non-DIsclosed Active Exchange Traded Fund

(71) Applicant: Robert S. Tull, JR., Levittown, PA (US)

(72) Inventor: Robert S. Tull, JR., Levittown, PA (US)

(21) Appl. No.: 14/946,970

(22) Filed: Nov. 20, 2015

Related U.S. Application Data
(60) Provisional application No. 62/095,833, filed on Dec. 23, 2014.

(51) Int. Cl. G06Q 40/04

(52) U.S. Cl. CPC G06Q 40/04

(57) ABSTRACT

Methodologies and systems for creating and trading non-disclosed exchange traded funds (“NDETFs”) that provide a means for market makers to monitor trading prices on public exchanges and to create a hedge on the non-disclosed securities that relate to a difference in value of two portfolio composition files (“PCF”), is disclosed. In one embodiment, the NDETF creates a standard PCF used to calculate an indicative intraday value, IIV1, of the ETF. A second PCF, being a pro-rata portion of the holdings of the NDETF at trade date minus one, is formed to calculate a second indicative intraday value, IIV2. The methodology determines the difference between IIV1 and IIV2 which is then used by market makers to create competitive bid/offer spreads on the NDETF and to create a hedge to manage intraday risk between the two IIVs. The final value of NDETF creation and redemption unit is determined after market close.

### CLAIM OF PRIORITY

This application claims the benefit of priority under 35 U.S.C. §119(e) from U.S. Provisional Patent Application Ser. No. 62/095,833, filed on Dec. 23, 2014, the benefit of priority of which is claimed hereby, and the content of which is incorporated by reference herein in its entirety as if set forth in full.

### FIELD OF THE INVENTION

The present invention generally relates to systems, processes, and methodologies for creating and trading financial securities funds, and more specifically relates to systems, processes, and methodologies used to create and trade non-disclosed exchange traded funds that provide a mechanism for market makers to quantifiably manage intraday risk and trading of the ETF. A core element of the systems and methodologies provides for the building of parallel ETF portfolio creation files (“PCF”) that are in turn used to calculate respective indicative intraday values (“IIV”) for each of the PCFs.

### Background of the Systems and Methodologies

Exchange Traded Funds (“ETF” or “ETFs”) are a form of investment vehicle that were first introduced to U.S. markets in 1993. The initial ETFs, called Standard and Poor's Depository Receipts (“SPDRs”), under ticker symbol “SPY,” were a unit trust designed to match the performance of the S&P 500 index. Since 1993, the creation and trading of ETFs on U.S. and international markets has grown exponentially. From their humble beginnings in 1993, listed U.S. ETF funds have grown in number to more than 1400, and assets under management now exceeds two trillion dollars. Additionally, assets gathered into ETFs have grown at an annual rate in excess of 25% since 1993.

Despite tremendous growth and continued interest in ETF investing, there are two primary approaches or models for active non-disclosed ETFs (“NDETF”) in the market. One model, called the blind trust approach, as illustrated in the top half of FIG. 1, provides that Authorized Participants (“AP”) deliver cash to the blind trust and the blind trust in turn purchases the securities necessary for the creation and redemption process with the ETF fund.

Two examples of such blind trust NDETF models are described in U.S. Pat. Nos. 8,285,624 and 8,630,926 both issued to Paul Kuhnle et al.

These Kuhnle et al. patent disclosures generally describe the administration and operation of a blind trust that engages a third party to purchase the underlying holdings of the NDETF and deliver to the authorized purchaser or retail investor, cash or securities as selected by the advisor that are equal to the value of a unit of the NDETF (an “NDETF Unit”). An NDETF Unit is equal to the net asset value (“NAV”) of the portfolio securities multiplied by a predetermined number of NDETF shares which are bundled into one NDETF Unit depository settlement. This model of NDETF trading does not have the transparency required by investors or the Securities Exchange Commission (“SEC”) to the underlying holdings of the trust. Instead, the underlying assets of the trust are disclosed only to the blind trust bank agent responsible for producing the indicative intraday value (“IIV”) which is published to the market during the trading day. Professionals may be able to approximate the underlying holdings of the NDETF using sophisticated applications, but this is impossible for the average investors (see Appendix A to the SEC response to Precidian ETF Trust available at https://www.sec, gov/rules/ic/2014/ic-31300.pdf.)

The second NDETF model, illustrated in lower half of FIG. 1, uses a portfolio creation file (“PCF”), similar to traditional ETFs, and a proxy price for intraday exchange pricing referred to as Exchange Traded Managed Funds (“ETMFs”). According to this model, the final trade prices that are assigned to the executed exchange orders are determined after the daily close of the exchange and after a NAV is calculated by the fund accountant. The actual NAV is calculated at the end of each trading day and is substituted for the proxy price after the close of the exchange. By way of example, the proxy price may be $100.00 and on each trading day the NDETF shares start trading at $100.00 plus or minus the investor's or market maker's differential price to be added to or subtracted from the proxy price. If differential price of the market maker bid is −$0.03 and his offer price is +$0.02 the exchange bid/offer would be seen by market participants as $99.97 at $100.02.

The above “second NDETF” models are further described in U.S. Pat. Nos. 8,655,756; 8,577,787; 8,452,682; and 7,496,531, each issued to Gastineau et al. The methodologies described in these patent disclosures are often referred to as “differential pricing methodologies” or “NAV based pricing” whereby the bid and offer spreads are based upon a price to be calculated in the future by a third party. As disclosed in these patents, the future calculated NAV price replaces the proxy price after the close of each day's exchange trading. The final exchange trade price is determined based upon the differences in value of the NAV less the premium or discount implied by reference to the proxy price execution order. Therefore, if the NAV for the NDETF example above is $25.00 for the final trade price, then the investor would be able to sell his shares at $24.97, and would be able to buy shares as $25.02.

In NDETF shares, the investor fixes the differential to the NAV in the broker's trade entry system. Moreover, the investor is required to bear the intraday market price risk until the exchange closes at the end of the day.

Neither of these current NDETF models fully considers or addresses the key interests of ETF exchange investors or the SEC. Important for exchange investors is the ability to monitor and respond to intraday fluctuations in the market prices and hence the NDETF's value and have transparency into the daily holdings of the ETF. As described above, current NDETF models do not provide any means for such information to be published, or a way to monitor and respond to such information. NDETF investors, like all investors who execute on public exchanges, look for investments which provide certainty in price of their orders, and a reduction in their exposure to the market as measured by the quantity of shares purchased or sold, times the traded share price, plus the commission to be charged by the executing broker for the securities bought or sold at the time of the exchange order execution. Where such certainty of trade price is lacking, investors are obviously trading at a disadvantage.

Accordingly, there is a need for an alternative and improved NDETF model and methodology for creating and trading of NDETFs that overcomes the deficiencies existing in the above described examples, and the deficiencies associated with current ETF models and methodologies.

### SUMMARY OF THE INVENTION

The present invention overcomes the disadvantages of the prior art and fulfills the needs described above by providing systems, processes, and methodologies for determining a fair price for the NDETF trade in relationship to the value of the NDETF holdings at the moment of trade execution.

A preferred aspect of the invention is a computerized methodology for creating and trading an active non-disclosed exchange traded fund (“NDETF”), comprising creating and calculating a quantified metric relating to risk values of said NDETF, said methodology comprising the steps of (a) creating a first portfolio composition file (“PCF1”) using an NDETF, said PCF1 being disclosed to the market to support market making activities on an NDETF creation/redemption unit on a per share value; (b) creating a second portfolio composition file comprising a pro-rata portion of actual holdings of the NDETF fund (“PCF2”), said PCF2 is not disclosed to the market, but is used to calculate the fair value of a the pro rata slice of the NDETF on a per share value; (c) calculating a first indicative intraday value (“IIV1”) of said NDETF using said PCF1, said calculation occurring approximately every 1 to 5 seconds, and publishing said IIV1 to the market in support of investors and market makers to determine an approximate share value of said PCF1, and thereby not permitting the front running of the NDETF fund or generating excess volatility that could harm current shareholders of the NDETF; (d) calculating a second indicative intraday value (“IIV2”) of said NDETF using said PCF2 to create a more accurate share value of one PCF2 share than would be represented solely by the PCF2 of the NDETF; (e) calculating a metric comprising a difference between said first and second indicative intraday values; (f) creating a hedge relating to said difference in value between said PCF1 and PCF2 by at least one market maker using said metric comprising a difference between said first and second indicative intraday values; and (g) determining a creation and redemption portfolio using said PCFs and said difference between said first and second indicative intraday values in order to support market making and investor activity on the NDETF fund.

In another embodiment, the invention is a computerized system for creating a plurality of quantified metrics relating to risk values of an active non-disclosed exchange traded fund, said system comprising (a) a specially programmed computer processor; (b) at least one database for maintaining at least data relating to holdings of said exchange traded fund; and (c) a plurality of real-time data feeds accessible by said computer processor, said plurality of real-time data feeds providing at least real-time data relating to said holdings of said exchange traded fund; wherein said computer processor executes a methodology, said methodology comprising the steps: (i) creating a portfolio composition file (“PCF”) using a non-disclosed exchange traded fund (“NDETF”), said PCF is disclosed to the market to support market making activities on an NDETF creation/redemption unit on a per share value; (ii) creating a second portfolio composition file comprising a pro-rata portion of actual holdings of said NDETF (“NDPCF”), where said NDPCF is not disclosed to the market but is used to calculate the value of a full disclosed pro rata slice of the NDETF on a per share value; (iii) calculating a first indicative intraday value of said NDETF using said PCF every 1 to 5 seconds and publishing said first indicative intraday value to the market to support investors and market makers to determine an approximate ETF share value of said representative portfolio, and thereby not permitting front running or excess volatility that could harm current shareholders of the NDETF; (iv) calculating a second indicative intraday value of said NDETF using said NDPCF to create a more accurate share value of one NDETF share than would be represented solely by the PCF; (v) calculating a metric comprising a difference between said first and second indicative intraday PCF values; (vi) at least one market maker using said metric comprising a difference between said first and second indicative intraday values to create a hedge relating to said difference in value between the PCF and NDPCF; and (vii) determining a creation and redemption portfolio using said PCF and said difference between said first and second indicative intraday values in order to support market making activity on the NDETF share.

### BRIEF DESCRIPTION OF THE DRAWINGS

For the purposes of illustrating the claimed invention, the attached drawings show several aspects and embodiments that are presently preferred. However, it should be understood that the invention is not limited to the precise methodology or process steps or system elements as shown in the accompanying drawings.

FIG. 1: is a flowchart illustration of certain prior art methodologies used to create and trade non-disclosed exchange traded funds;

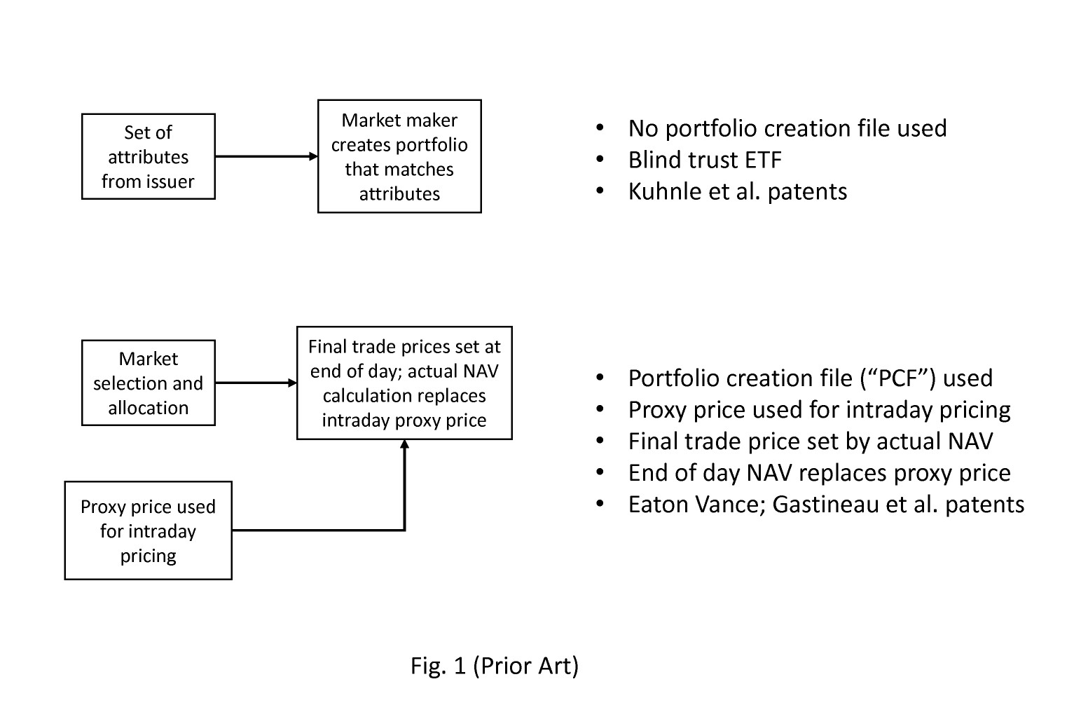

FIG. 2: is a flowchart illustration of an exemplary embodiment of certain methodology steps used within the inventive methodology to create and trade a non-disclosed exchange traded fund;

FIG. 3: is another flowchart illustration of an exemplary embodiment of certain methodology steps undertaken within the inventive methodology to create and trade a non-disclosed exchange traded fund allowing market makers to create a hedge to cover the “fat tail” risk of the intraday exposure to the NDETF securities not disclosed to the market in PCF1;

FIG. 4: is a flowchart illustration showing an exemplary embodiment of the FIG. 2 and FIG. 3 methodology calculation steps undertaken to determine market volatility and to assess impact on NDETF;

FIG. 5: is a flowchart illustration of an exemplary embodiment of a timeline calculation and analysis of indicative intraday values for both PCF1 and PCF2;

FIG. 6: is a flowchart illustration of an exemplary embodiment of a timeline calculation of intraday volatility metrics for both PCF1 and PCF2; and

FIG. 7: is an exemplary embodiment of a system schematic showing certain system components for creating and trading a non-disclosed exchange traded fund on an exchange or in the over the counter market

### DETAILED DESCRIPTION OF CERTAIN PREFERRED EMBODIMENTS

An innovative model and methodology for creating and trading of a non-disclosed exchange traded fund is described through the following several preferred embodiments for active non-disclosed ETF models, methodologies, and systems. A key aspect of the disclosed methodologies and systems is that such methodologies and systems provide a means for market makers to quantifiably assess and manage intraday market risks, for a non-disclosed ETF fund in order to provide real time bid/offer spreads against which investors can execute trades.

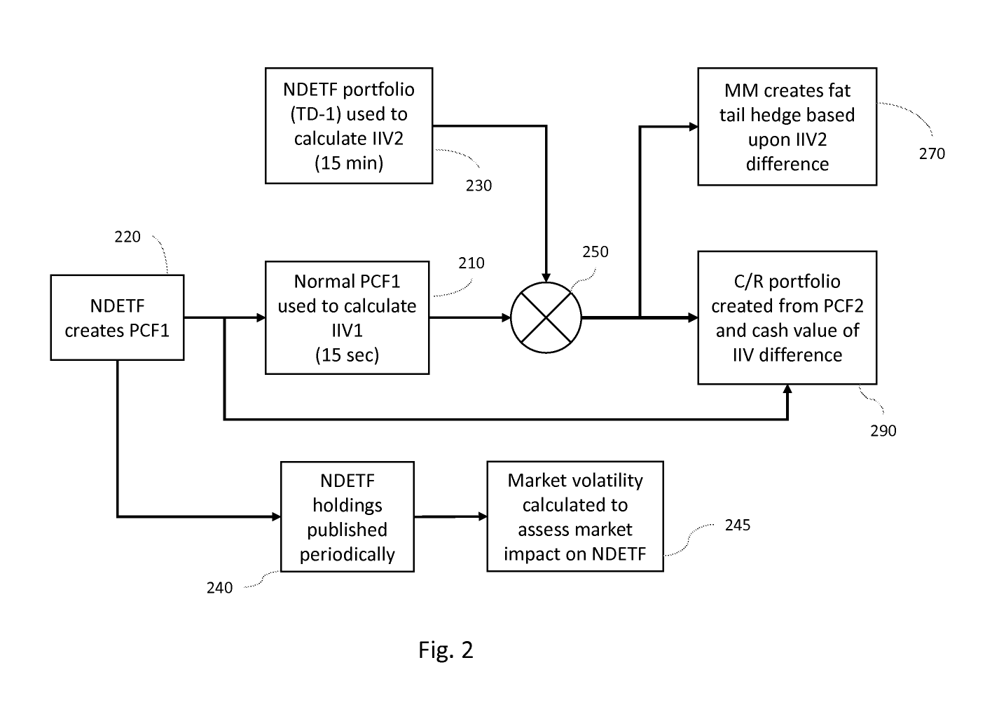

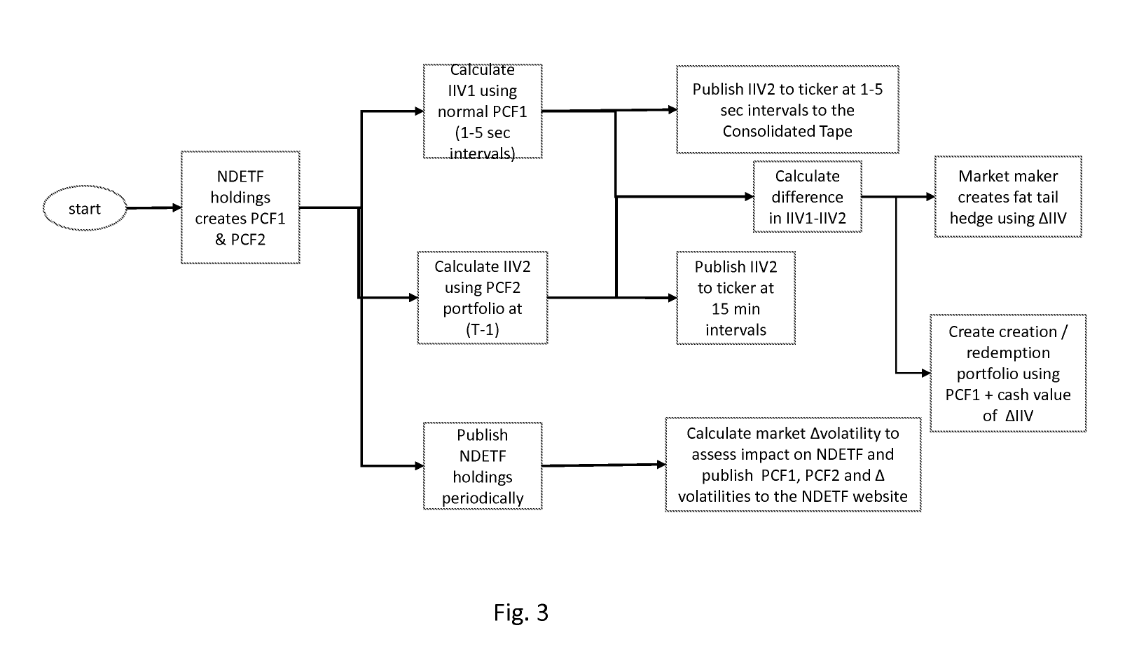

At its core, as illustrated in the FIGS. 2 and 3 flowcharts, the inventive system, methodology and model comprises the creation and trading of parallel NDETF portfolio composition files (“PCFs”) which define the value of an NDETF Unit which is equivalent to the value of a defined number of NDETFs shares that are redeemed or created by an Authorized Participant having a contract with the NDETF. The two or parallel portfolios are created from (a) a non-disclosed ETF fund, or NDETF, using a first methodology (“Method1”) defined and disclosed to investors in the fund, and (b) a pro-rata net asset value (“NAV”) slice of the PCF of the actual holdings of the non-disclosed ETF fund that is equivalent in value to the portfolio generated by or in Method2 in the Unit value and composed of security holdings and cash. Once each portfolio is prepared according to a stated methodology, the two portfolios are each used to calculate respective indicative intraday values (“IIVs”) for the two portfolios, and referred to as IIV1 and IIV2.

### Description of Method1

Method1 portfolios may be constructed using many of the same processes that are currently used in the ETF marketplace, although alternative processes for creation of the Method1 portfolios may also be used so long as the objectives described herein are incorporated. One objective of the Method1 process is to remove a percentage of NDETF holdings from the PCF composition in order to prevent professional market makers from reverse engineering the NDETF holdings between disclosure periods. The current method defines a PCF as consisting of a portfolio of holdings equal to the value of one Unit. A Unit is defined as a specific number of NDETF shares multiplied by the value of the most recent computed NAV. A NAV is the value of one fund's shares equal to the total value of all fund assets divided by the number of shares issued by the funds. Many ETF Units consist of 50,000 shares and each Unit must be equal to or greater than one million U.S. dollars ($1MM) on the launch date of the listed index ETF on a public stock exchange in the United States.

Unique to Method1 is the process to remove NDETF holdings following rules as further disclosed below. Method1alleviates key SEC concerns regarding possible front running of NDETF fund orders and free riding on the investment strategy of the NDETF fund advisor which could result in negative impacts to the NDETF shareholders. The Method1 portfolio will be used for creation and redemption of NDETF Units and is defined by the composition of cash and securities listed in PCF1.

The PCF1 will contain a minimum of holdings of the NDETF fund as required by regulatory approvals. More particularly, Method1 defines the PCF1 security selection process on trade date minus one business day (“T-1”) for the construction of the trade date (“T”) PCF1 to prevent front running and free riding opportunities by market professionals on the NDETF fund. The percentage of securities removed from the NDETF portfolio creation file is derived from the holdings as of the NDETF fund at the close of business on date T-1, adjusted to reflect all creations and redemptions of NDETF shares, plus all accounting events that will affect the value of the NDETF on date T. Moreover, the percentage of non-disclosed holdings removed from the portfolio will be limited in a manner so as to make it extremely complex and costly to reverse engineer all of the holdings and proper weightings of each of the security holdings in the NDETF fund. This protects current and future investors in the NDETF, and supports the policies and objectives of the SEC.

A sample of exemplary embodiment rules are presented here, but many alternative rule options can be created to achieve similar results using some or all of the core rules stated below:
a. Removal of securities having 5% or more of the NDETF holdings and replacing them with cash such that no more than 20% of the holdings have been eliminated in the process;
b. Removing 20% of the overall mid-weighted securities of the NDETF holdings and replacing them with cash or securities not contained within the NDETF but which may perform similar to the current NDETF holdings on date T;
c. Reweighting the top holdings such that 20% of the portfolio has been replaced with cash equivalents on date T;
d. Removing derivative securities from the NDETF holdings and replacing them with their current cash value on date T;
e. Adding short positions to the NDETF holdings equal to 10% of the NDETF holdings; and/or
f. Any one or more combination of the above rules, and/or any combination of activities that would make it difficult to reverse engineer the NDETF holding on date T, so long as the calculation of IIV1 remains accurate and fairly represents the value of one NDETF share on date T.

Many more options or rules can be developed to achieve the masking of all of the NDETF holdings such that the NDETF holdings cannot easily be reversed engineered by the market makers during market trading hours or between disclosure periods of NDETF.

As shown in the FIG. 2 flowchart, IIV1 is calculated 210 during the exchange trading hours from the disclosed PCF using Method1. The disclosed PCF1 is created 220 from the NDETF fund, and an indicative real time per share value disseminated by the IIV1 calculation agent to the ETF marketplace. This IIV1 may also be referred to as the Constant Fair Valued IIV (“CFVIIV”). In preferred embodiments, the CFVIIV will be published to the tape every 1 to 5 seconds to the ETF marketplace. The CFVIIV will require a third party calculation agent to capture the changes in value of each security within PCF1 and multiplied by the share quantity as quickly as each price of the securities in the PCF1 change in value during exchange trading hours.

In the market today, the IIV is published using the ETF exchange symbol with an .IV extension (e.g., SPY.IV). The CFVIIV could be published using the current extension (.IV) or could be published using a different extension. The CFVIIV would include the real time value of one share and will also include the value of (a) the securities, (b) expected income and expenses for the NDETF for the trade date, (c) a change in share quantity that would occur on trade date resulting from corporate actions, and (d) any estimated cash difference expected on trade date needed to equal one Unit divided by the number of NDETF shares in each Unit. Given the volume of dynamic data, and need for real-time determination and publication of such analyzed data, the CFVIIV cannot be calculated manually, and can only be determined, used, and published according to the intentions of the disclosed system through use of one or more computer processors or systems as illustrated in FIGS. 2 and 3, and the specific flowchart steps 210 and 220. Moreover, such complete systems, algorithms, and methodologies are not part of any current ETF marketplace practice or systems.

The IIV2 is calculated, as shown in flowchart at step 230, from a pro-rata slice of the actual holdings in the NDETF fund equal to the value of one NDETF Unit as determined by the last calculated NAV and will be referred to as PCF2. The IIV2 calculation on PCF2 will be undertaken at a longer time interval in order to protect current shareholders in the NDETF. As shown in FIG. 2, in one embodiment, the calculation of IIV2 may be undertaken 230 and published every 15 minutes, although in other embodiments of the inventive system, shorter or longer periods other than 15 minutes may alternatively be used.

The IIV2 calculation will also use a symbol extension to reflect the per share value of each security within the PCF2 that includes (a) share quantities multiplied by the price for each security at the end of each time period, (b) the expected income and expenses for trade date,(c) real time changes in foreign currency values during exchange trading hours, (d) the inclusion of fair value securities values during market hours, (e) implied values for illiquid securities, (f) cash equivalents and (g) any change in share quantities expected to occur on trade date as a result of corporate actions. Both the CFVIIV and the IIV2 would be adjusted to include any topping off cash estimates needed during the trade date NAV calculation to equal one Unit. As described above, it is clear that given the volume of highly dynamic data, and the need for real-time determination and publication, the calculation of the CFVIIV and IIV2 is simply not possible without the use of at least one specially programmed processor.

As shown in FIGS. 2 and 3, a delta or difference between the CFVIIV and IIV2 share values will be calculated 250, and this difference in value will be published to permit investors to track the real time value differences between the two portfolio IIVs. The price difference creates a type of market disclosure metric? currently not captured by any single IIV calculation, NAV based pricing or blind trust pricing. The value difference disclosure will help the arbitrage process of market makers during exchange hours. Moreover, price spikes, bad prints, and any lack in underlying security components prices of PCF1 and PCF2 will affect both IIV calculations and be reflected in either an expansion or compression in price difference that permits arbitrage traders to adjust their hedge portfolios and maintain a valid arbitrage pricing process for investors. Accordingly, the price differential metric provides the type of product disclosure and information not contained in any prior art systems or methodologies.

Market makers could use the difference to create 270 and adjust their “fat tail” hedge relating to the difference in the indicative intraday values and thereby provide a means to adjust hedging risks between the two PCF values. It is important to note that all trades executed on the NDETF listed shares will be at market prices and will not be dependent upon the closing NAV per share of the NDETF, as NAV calculations are determined using T-1 security holdings in the NDETF and adjusted to trade date closing prices. Only creations and redemptions by Authorized Participants who have a contractual relationship with the NDETF can create NDETF Units at NAV on trade date and thus increase or decrease the number of NDETF shares in the market to balance investor demand.

Upon the daily close of exchange trading, the fund advisor will collect the values of CFVIIV, IIV2, the exchange closing price of the NDETF share, along with the NAV of the NDETF, and will publish this data to the NDETF website. These differential values will be overlaid daily so as to reduce the potential for front running and free riding opportunities against the NDETF. Moreover, the advisor will retain these values offline for subsequent regulatory review.

In addition to the value difference between CFVIIV (also labelled as IIV1) and IIV2, the current invention will also determine the volatility difference between PCF1 and PCF2. The volatility difference will provide investors with a numerical factor that provides investor transparency between the two PCFs on an intraday basis. This additional volatility metric will be expressed as a percentage between the volatility of PCF1 (“Vol1”) as compared to (divided by) the volatility of PCF2 (“Vol2”). This percentage accordingly reports the volatility differences under current market conditions and will change over time as the PCF1 and PCF2 change.

The mathematical expression for this volatility metric may be shown as: Vol1/Vol2 =PVD (“portfolio volatility difference between PCF1 [partially disclosed NDETF holdings] and PCF2 [pro rata slice of all NDETF holdings [actual NDETF holdings as the market increases or decreases in volatility”]).

The regulatory requirement of sixth decimal place calculation will be rounded to five decimal places and sent to the NDETF website daily after the market close. By way of example of how to interpret and use the PVD, if the resulting PVD is equal to 1, then PCF1 and PCF2 had equal market volatility which will help the market makers adjust their arbitrage trading process for the next trading day. Similarly, if PVD is less than 1, then the PCF1 is less volatile than PCF2, and where PVD is greater than 1, then the PCF1 holdings are more volatile than the PCF2 holdings. The greater the difference in PVD and unity, the more fat tail adjustments are needed intraday between PCF1 than PCF2 to maintain small spreads between the bid and offer exchange prices.

The creation/redemption portfolio for the NDETF unit is created 290 using the PCF1 and adding to the PCF1 portfolio value cash equal to the difference between the closing NAV per share of the NDETF fund multiplied by the NDETF Unit shares. Upon creation 290 of the redemption/creation portfolio, the NDETF share value captures the equivalent value of the IIV2 in addition to income, expenses, and other corporate actions that occur to the NDETF fund as of the trade date close. In equation form, the creation/redemption portfolio value of the NDETF may be shown as:

C/R Portfolio=(NAV per share)*(the number of shares in an NDETF Unit)

The final value of each Unit is determined by the fund administrator and fund accountant after the exchange market close. Moreover, because the final Unit value can be closely estimated by the market makers, the market makers are able to close out their previously created intraday fat tail positions used to hedge the difference between PCF1 value at or after the market close and the final or actual NAV.

As shown in FIG. 2, the disclosed methodology and process also provides for the publication 240 of the actual portfolio holdings of the NDETF fund on a periodic or regular basis. The timing for the publication 240 of the NDETF holdings will be determined based upon a number of factors including the investment strategy, the size of the NDETF, and market turnover of holdings within the NDETF annually. Specifically, the market volatility is monitored and determined in order to assess the market impact on the NDETF value. For example, an algorithm of this application could determine the anticipated impact of front running by the electronic trading community (also known as “Algo Trading,” “Algo Community,” “Black Box Trading,” or “automated electronic trading”). As the fund size increases, the publication 240 of the holdings would be less frequent in order to protect investors in the NDETF fund from reverse engineering of the NDETF holdings. A key to this analysis and determination will be the capacity of the investment strategy to gather assets without suffering performance drag. More particularly, if the Algo Community increases the volatility of the fund shares through various front running strategies or other reverse engineering techniques, investors can be harmed.

By way of background, Algo Trading uses computer programs for entering trading orders by one or more computer executed algorithms operating pre-programmed trading instructions and using variables including timing, price, or quantity of the order. Given that Algo Trading is computer technology based, the timing of such trading is most often measured in milliseconds and microseconds. Algo Trading is widely used by high frequency traders, and investment banks, to determine if investors are selling or buying, and how the Algo trader may be able to extract information and profits by front running the order or changing their current bid/offer prices to take advantage of the market. Sell side traders, such as market makers and some hedge funds, provide liquidity to the market, and also use Algo Trading as a means of generating and executing orders automatically and very quickly. Algo Trading may be used as part of or in-grained within many investment strategies, including market making, inter-market spread trades, and/or arbitrage strategies, and are occasionally used in spoofing trades, which is illegal.

FIG. 3 illustrates an alternative flowchart representation of an embodiment of the methodology and process providing for the parallel calculation of IIVs, determination of a creation/redemption portfolio based upon the Portfolio Composition File (“PCF”) and cash value of the difference in the IIVs, the periodic publication of the NDETF holdings, and the calculation of market volatility to permit monitoring and assessing of market activity on the value of the NDETF. More particularity, the volatility of the fund and an NDETF share are calculated or measured 245 regularly so that the investment management process can regulate the investment process of the NDETF fund and manage the market impact costs to the fund. Such calculations and assessment also provide a means to protect returns available to the investors that may be otherwise lost due to enhanced market volatility.

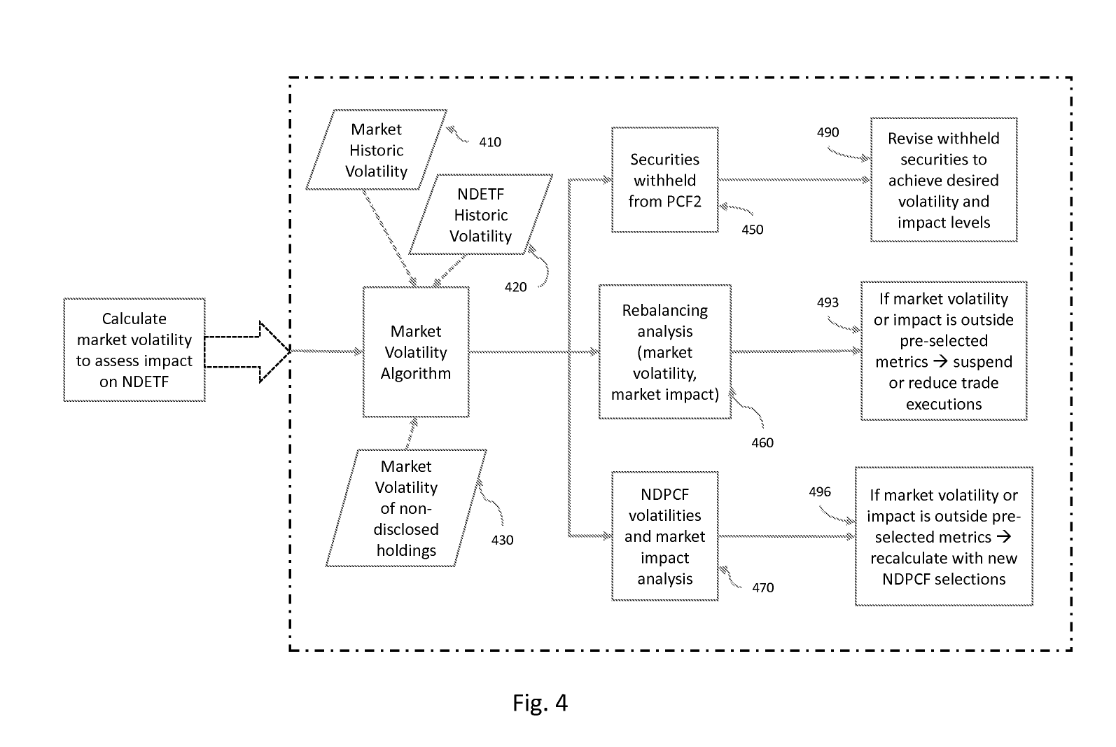

In further detail, as illustrated in FIG. 4, the calculation step/algorithm 245 for market volatility involves consideration and analysis of various data. One embodiment provides for three aspects of information and data used for the market volatility analyses including (a) current market volatility data 410, (b) portfolio volatility of the NDETF 420, and (c) current market volatility of the non-disclosed holdings of the NDETF 430. The methodology analyzes current market data and provides output data including at least (a) an output file of proposed securities to be withheld from the PCF 450, (b) a file of the analyses relating to proposed rebalancing based upon market volatility and market impact 460, and (c) a file of the analyses relating to volatility and market impact on the non-disclosed PCF (PCF2) 470.

As further illustrated in FIG. 4, with this analysis, certain adjustments, rebalancing, and investment decisions can be implemented. By way of example, based upon the output file of the proposed securities to be withheld, the non-disclosed ETF holdings could be adjusted 490 to achieve a desired level of volatility, and to address the impact of certain market impact costs. Similarly, based upon the analysis file relating to proposed rebalancing built upon market volatility and market impact, if the market volatility exceeds pre-determined levels, then daily security turnover could be reduced or altogether suspended 493. Finally, based upon the analysis file relating to volatility and market impact on the non-disclosed PCF (PCF2), if the volatility and impact metrics exceed pre-determined levels, then a modified PCF2 basket, created according to the Method2 of the NDETF, and the analysis can be recalculated to determine whether volatility and impact metrics are within the selected metrics levels 496.

As described, a key element and aspect of the inventive methodology and process is the parallel calculation of the IIV1 and IIV2, and the associated calculation, by the market makers, that permits them to adjust their intraday hedge based upon the difference between the IIV1 and IIV2. The IIV2 will not exclude from its preparation any security held in the NDETF fund, including securities in the holdings in T-1, and will adjust for all trade date creations and redemptions that increase or decrease the shares outstanding of the NDETF. The parallel calculation of the two indicative intraday values, and the creation of a hedge based upon the difference in the IIV1 and IIV2 allows the market makers to arbitrage the difference in values between the PCF1 and the PCF2 throughout the trading day. A second key aspect of the inventive methodologies is the periodic calculation of market volatility relating to PCF portfolio values. Such a periodic calculation provides a means to assess market risks periodically on the non-disclosed NDETF holdings.

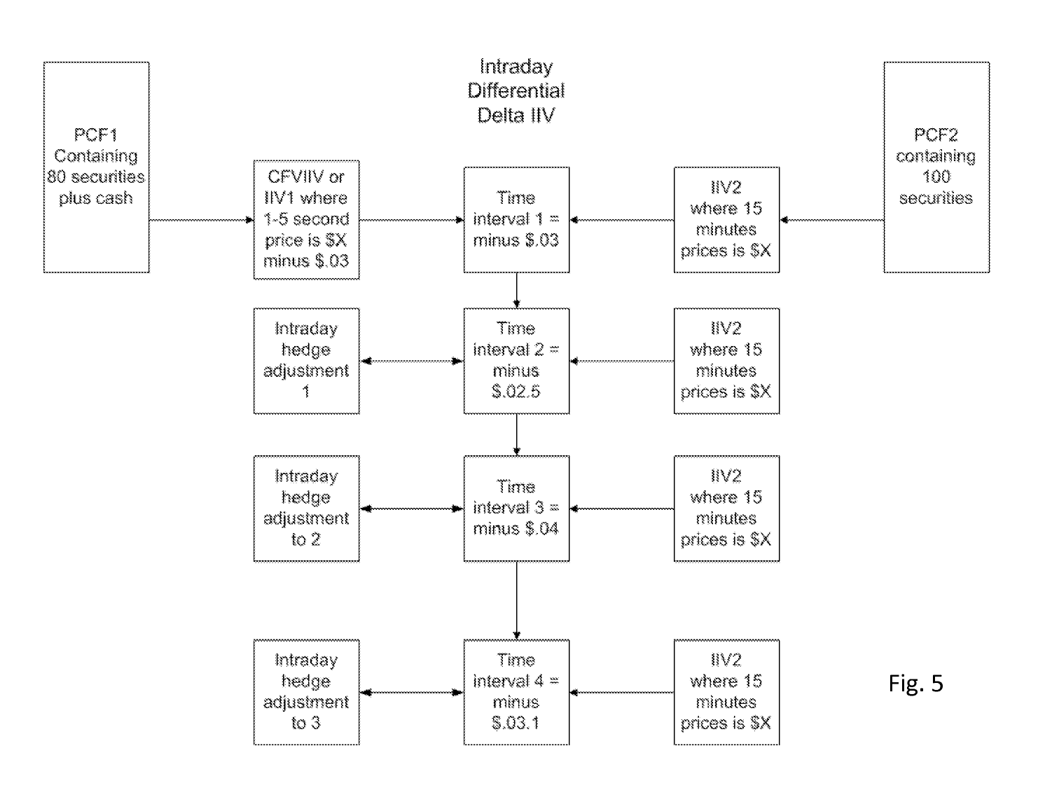

FIG. 5 illustrates an example flowchart of the timeline determination of the intra-trading day differential IIVs based upon the values of PCF1 and PCF2. As shown in the FIG. 5 example, at the first time interval, the difference in value between IIV1 (determined at every 1 to 5 seconds during the trading day) and IIV2 (determined at every 15 minutes during the trading day) is $−0.03. At the next time interval, the first intraday hedge adjustment will be calculated and applied, such that the difference in value between the two IIVs is $−0.025. At the third time interval, a second intraday hedge adjustment has been determined and applied, and the difference in the value of the IIVs is $−0.04. At the next time interval, and in view of the determination and application of a third intraday hedge adjustment, the IIV differential is $−0.031. This process continues throughout the trading day.

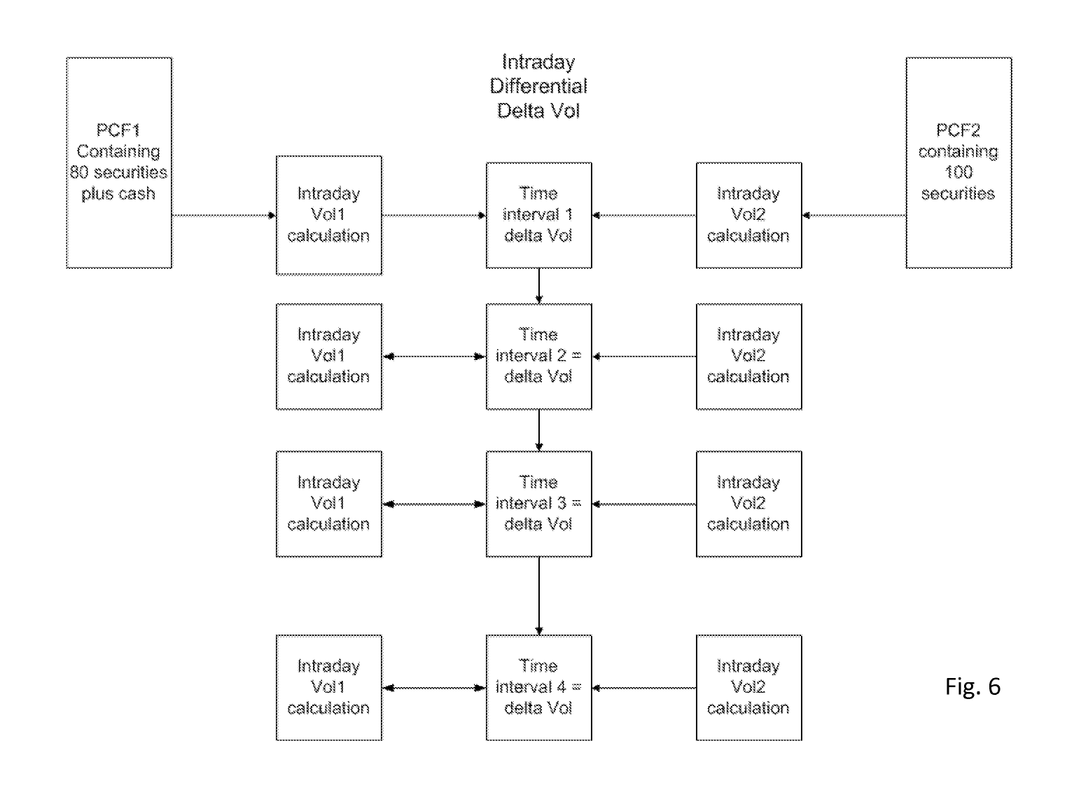

Similarly, FIG. 6 illustrates an example flowchart of the timeline calculation of the intra-trading day differential volatility of PCF1 and PCF2. At an initial time interval (“time interval 1”), and at each subsequent time interval, the system and algorithms calculate an intraday volatility for PCF1, labeled as Vol1, and calculate an intraday volatility for PCF2, labeled as Vol2. Upon the calculation of Vol1 and Vol2 at each time interval, the system further determines a portfolio volatility difference, PVD, as described above. It is expected that this information will not be published to the market, but will instead be used to help manage the Method variables.

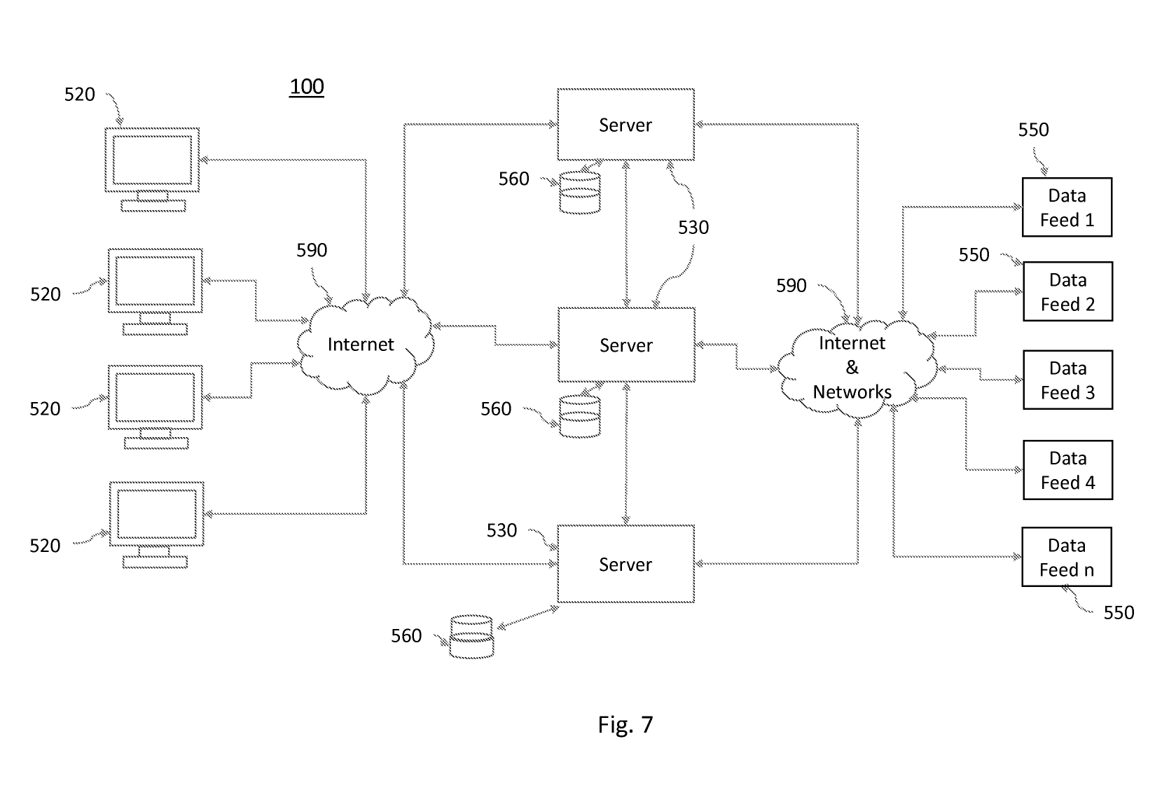

A description of the system 100 that may be used to implement and operate the disclosed methodologies and processes is shown in FIG. 7. As illustrated in FIG. 7, a plurality of servers 530 may be configured to execute or operate the above described methodology or processes. Each server 530 may be interconnected with the other servers 530, as well as to a global communications networks or the Internet 590. The connection to the Internet and any data provider 590 provides a means for the servers or processors 530 to receive a plurality of real-time data feeds from multiple data sources 550. Each server 530 is also directly connected with associated data storage or data memory 560. The respective data storage 560 is necessary and configured to maintain historical fund data as well as necessary metrics of non-fund data used by Method1 in support of the investment scheme and analyses.

The market community 520, including market makers, connection with the methodology output may be through the Internet 590 or other data transmission provider 590 as also shown in FIG. 7. The books and records of the NDETF will reside at the Trustee's and the Advisor's systems. The data retained on the servers 530 and the data retained by the Trustee will be reconciled daily between all copies of the books and records using programs within the servers so that the preparation of the PCF1 and PCF2 will be accurate, complete in all its components, and will be forwarded to the Trustee for each T-1 night for use on the trade date prior to the exchange open. The Trustee will be able to audit the PCF1 and PCF2 to insure the data is not corrupted. Further, the Trustee will forward the reconciled data on T-1 to the National Clearing Corporation, in proper format, for distribution each night after each trade day to the Authorized Participants, market makers, and data distribution providers for availability and use upon the opening of exchange trading on each trading day.

While preferred embodiments of the inventive methodologies and systems have been described and disclosed, in particular with reference to certain figures and exemplary embodiments of various non-disclosed exchange traded funds, such exemplary representations are not to be construed as limiting the scope of application of the inventive methodologies or systems. More particularly, in reference to the illustrated NDETF, other and alternative embodiments of creating NDETFs may be implemented and operated using the inventive methodologies and systems. For example, the disclosed methodologies, processes, and systems would work equally well for any group of listed collective investments where there is a desire to limit the volatility and front running of large transition trades and free riding on an investment strategy of a collective investment.

It will be recognized by those skilled in the art that other modifications, substitutions, and/or other applications are possible and such modifications, substitutions, and applications are within the true scope and spirit of the present invention. It is likewise understood that the attached claims are intended to cover all such modifications, substitutions, and/or applications.

what is claimed is:

1. A computerized methodology for creating and trading an active non-disclosed exchange traded fund (“NDETF”), comprising creating and calculating a quantified metric relating to risk values of said NDETF, said methodology comprising the steps of:
a. Creating a first portfolio composition file (“PCF1”) using an NDETF, said PCF1 being disclosed to the market to support market making activities on an NDETF creation/redemption unit on a per share value;
b. Creating a second portfolio composition file comprising a pro-rata portion of actual holdings of said PCF1 (“PCF2”), said PCF2 is not disclosed to the market, but is used to calculate the fair value of a fully disclosed pro rata slice of the NDETF on a per share value;
c. Calculating a first indicative intraday value (“IIV1”) of said NDETF using said PCF1, said calculation occurring approximately every 1 to 5 seconds, and publishing said IIV1 to the market in support of investors and market makers to determine an approximate share value of said PCF1, and thereby not permitting the front running of the NDETF fund or generating excess volatility that could harm current shareholders of the NDETF;
d. Calculating a second indicative intraday value (“IIV2”) of said NDETF using said PCF2 to create a more accurate share value of one PCF2 share than would be represented solely by the PCF2 of the NDETF;
e. Calculating a metric comprising a difference between said first and second indicative intraday values;
f. Creating a hedge relating to said difference in value between said PCF1 and PCF2 by at least one market maker using said metric comprising a difference between said first and second indicative intraday values; and
g. Determining a creation and redemption portfolio using said PCFs and said difference between said first and second indicative intraday values in order to support market making and investor activity on the NDETF fund.

2. The computerized methodology for creating and trading an active non-disclosed exchange traded fund, as described in claim 1, wherein the non-disclosed exchange traded fund is periodically published to the marketplace.

3. The computerized methodology for creating and trading an active non-disclosed exchange traded fund, as described in claim 1, wherein the first indicative intraday value is published to the market approximately every 1 to 5 seconds.

4. The computerized methodology for creating and trading an active non-disclosed exchange traded fund, as described in claim 1, wherein the second indicative intraday value is published to the market at a time interval different from when the first indicative intraday value is published, and at a time interval as defined within an associated prospectus.

5. The computerized methodology for creating and trading an active non-disclosed exchange traded fund, as described in claim 4, wherein the second indicative intraday value is published to the market approximately every 15 minutes.

6. The computerized methodology for creating and trading an active non-disclosed exchange traded fund, as described in claim 1, wherein at least one market maker creates a hedge relating to said active NDETF fund share or group of shares to arbitrage differing values between said disclosed PCF share values and said NDPCF share values.

7. The computerized methodology for creating and trading an active non-disclosed exchange traded fund, as described in claim 1, further comprising the step of periodically calculating market volatility relating to said NDETF and calculating market impact costs associated with said NDETF, and publishing said information on an NDETF website for review by market participants or to a consolidated tape.

8. A method for creating a quantified metric relating to risk values of a non-disclosed active exchange traded fund, with such metric allowing at least one market maker to create a fat tail hedge relating to said active exchange traded fund, wherein said method is operated on a computer such that said metric can be calculated and published in real time; said method comprising the steps:
a. Creating a portfolio composition file (“PCF1”) using a non-disclosed exchange traded fund (“NDETF”);
b. Creating a second portfolio composition file (“PCF2”) comprising a pro-rata portion of all actual holdings of said NDETF;
c. Calculating a first indicative intraday value of said NDETF share using said PCF1;
d. Calculating a second indicative intraday value of said NDETF using said PCF2 based upon holdings within the NDETF fund at trade date minus one business day;
e. Calculating a quantified metric comprising a difference between said first and second indicative intraday values;
f. At least one market maker using said metric comprising a difference between said first and second indicative intraday values and volatility differences to create a hedge relating to said active NDETF fund; and
g. Determining a creation and redemption portfolio using said PCF and said difference between said first and second indicative intraday values.

9. A computerized system for creating at least one quantified metric relating to risk values of an active non-disclosed exchange traded fund, said system comprising:
a. at least one specially configured computer processor;
b. at least one database accessible in real-time by said at least one computer processor, said database at least maintaining data relating to holdings of said exchange traded fund;
c. a plurality of real-time data feeds accessible by said at least one computer processor, said plurality of real-time data feeds providing at least real-time data relating to said holdings of said exchange traded fund;
wherein said computer processor executes a methodology, said methodology comprising the steps of:
i. monitoring pricing and trading frequency of a plurality of various market holdings;
ii. monitoring pricing and trading frequency of said market holdings of said exchange traded fund;
iii. calculating a first volatility metric for said plurality of various market holdings;
iv. calculating a second volatility metric for said market holdings of said exchange traded fund;
v. identifying holdings from said exchange traded fund where said holdings are in transition;
vi. excluding said identified transition holdings from said exchange traded fund;
vii. generating a cash value of said excluded pro-rata holdings;
viii. generating a cash value of a pro-rata slice of said exchange traded fund portfolio excluding said excluded holdings;
ix. adding said cash value of said excluded holdings to said cash value of said pro-rata slice of said exchange traded fund portfolio excluding said excluded holdings; and
x. constructing a creation/redemption portfolio using a pro-rata slice of said added cash values calculated in step (ix) above and any difference to the closing Unit value of the NDETF being topped off in cash.

10. The computerized system for creating at least one quantified metric relating to risk values of an active non-disclosed exchange traded fund, with such metric allowing the creation of a hedge relating to said active exchange traded fund, as described in claim 9, wherein said holdings in transition are at least one of the following: holdings being sold, holdings being bought, holdings subject to ownership restrictions, non-liquid holdings, and holdings subject to ex-date corporate actions.

11. A computerized system for creating a plurality of quantified metrics relating to risk values of an active non-disclosed exchange traded fund, said system comprising:
a. a specially programmed computer processor;
b. at least one database for maintaining at least data relating to holdings of said exchange traded fund; and
c. a plurality of real-time data feeds accessible by said computer processor, said plurality of real-time data feeds providing at least real-time data relating to said holdings of said exchange traded fund;
wherein said computer processor executes a methodology, said methodology comprising the steps:
i. creating a portfolio composition file (“PCF”) using a non-disclosed exchange traded fund (“NDETF”), said PCF is disclosed to the market to support market making activities on an NDETF creation/redemption unit on a per share value;
ii. creating a second portfolio composition file comprising a pro-rata portion of actual holdings of said NDETF (“NDPCF”), where said NDPCF is not disclosed to the market but is used to calculate the value of a full disclosed pro rata slice of the NDETF on a per share value;
iii. calculating a first indicative intraday value of said NDETF using said PCF every 1 to 5 seconds and publishing said first indicative intraday value to the market to support investors and market makers to determine an approximate ETF share value of said representative portfolio, and thereby not permitting front running or excess volatility that could harm current shareholders of the NDETF;
iv. calculating a second indicative intraday value of said NDETF using said NDPCF to create a more accurate share value of one NDETF share than would be represented solely by the PCF;
v. calculating a metric comprising a difference between said first and second indicative intraday PCF values;
vi. at least one market maker using said metric comprising a difference between said first and second indicative intraday values to create a hedge relating to said difference in value between the PCF and NDPCF; and
vii. determining a creation and redemption portfolio using said PCF and said difference between said first and second indicative intraday values in order to support market making activity on the NDETF share.

12. The computerized system for creating a plurality of quantified metrics relating to risk values of an active non-disclosed exchange traded fund, as described in claim 11, wherein the non-disclosed exchange traded fund is periodically published to an exchange.

13. The computerized system for creating a plurality of quantified metrics relating to risk values of an active non-disclosed exchange traded fund, as described in claim 11, wherein the first indicative intraday value is published to an exchange approximately every 15 seconds.

14. The computerized system for creating a plurality of quantified metrics relating to risk values of an active non-disclosed exchange traded fund, as described in claim 11, wherein the second indicative intraday value is published to an exchange at a time period longer than every 15 seconds.

15. The computerized system for creating a plurality of quantified metrics relating to risk values of an active non-disclosed exchange traded fund, as described in claim 14, wherein the second indicative intraday value is published to an exchange at an approximate 15 minute time period.

16. The computerized system for creating a plurality of quantified metrics relating to risk values of an active non-disclosed exchange traded fund, as described in claim 11, further comprising the step of periodically calculating market volatility relating to said NDETF and calculating market impact costs associated with said NDETF.
